(19) United States
(12) Patent Application Publication
(10) Pub. No.: US 2009/0002646 A1
(43) Pub. Date: Jan. 1, 2009

(54) ANGLE-ADJUSTING ASSEMBLY AND ANGLE-ADJUSTING MECHANISM THEREOF

(75) Inventors: Wen-Chi Fu, Hsinchu (TW); Tai-Li Chang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/943,585

(22) Filed: Nov. 21, 2007

(30) Foreign Application Priority Data
Jun. 27, 2007 (TW) 96123201

(51) Int. Cl. G03B 21/14

(52) U.S. Cl. 353/119

(57) ABSTRACT

An angle-adjusting mechanism includes a first disk, a second disk, a fixing element and an elastic element. The first disk has a spindle hole and a plurality of positioning end notches disposed adjacent to the spindle hole. The second disk has a spindle fitting the spindle hole to enable the first disk to rotate around a rotation axis of the spindle relative to second disk, and has a positioning end bump located adjacent to the spindle to engage with one of the positioning end notches. The fixing element mounts the second disk onto the supporting bracket and limits the second disk to move along the rotation axis of the spindle within a preset range. The elastic element is mounted between the fixing element and the second disk to force the second disk to lean on the first disk.

### CROSS-REFERENCE TO RELATED APPLICATION

This application claims the priority benefit of Taiwan application serial no. 96123201, filed on Jun. 27, 2007. All disclosure of the Taiwan application is incorporated herein by reference.

### BACKGROUND OF THE INVENTION

1. Field of the Invention

The present invention generally relates to an angle-adjusting assembly and an angle-adjusting mechanism thereof, and more particularly, to an angle-adjusting assembly and an angle-adjusting mechanism thereof applied in a projector.

2. Description of Related Art

Along with the advancement of science and technology, diverse projection apparatuses have been used in various situations, such as briefing, address, theater, audio-visual teaching, interactive teaching, home theater, and the like. In order to fit user's demands, the exterior design of a projection apparatus tends towards a delicate and compact profile where a foot stand is disposed for adjusting the projection angle of the projection apparatus.

The angle-adjusting device of a common projector includes a bolt mechanism or a link rod mechanism. Taking an adjusting device with a bolt mechanism as an example, a bolt capable of adjusting the height of a projector is disposed at the bottom of the projector, and a user manually turns a knob located at the lower end of the bolt to adjust the distance between the knob and the bottom of the projector and thereby further adjust the elevation angle of the optical axis of the lenses of the projector relative to the plane for placing the projector.

In a projector using the adjusting device with a bolt mechanism however, the front weight of the body of the projector is supported by a single knob with a limited area only. Thus, both sides of the body of the projector lack effective supports, which likely causes unstable center of gravity of the projector. Therefore, when the projector is subjected to an external force, the body of the projector tends to sway very easily.

### SUMMARY OF THE INVENTION

Accordingly, the present invention is directed to an angle-adjusting mechanism for adjusting the angle made by the case and the supporting bracket of a projector that rotate around a rotation axis.

Accordingly, the present invention is directed to an angle-adjusting assembly for adjusting the angle made by the case and the supporting bracket of a projector that rotate around a rotation axis.

An embodiment of the present invention provides an angle-adjusting mechanism adapted to be installed between a case and a supporting bracket of a projector. The angle-adjusting mechanism includes a first disk, a second disk, at least a fixing element and at least an elastic element. The first disk has a spindle hole and a plurality of positioning end notches disposed adjacent to the spindle hole. The second disk comprises a spindle which is fitted the spindle hole, so that the first disk rotates around a rotation axis of the spindle relative to the second disk, and comprises at least a positioning end bump disposed beside the spindle and able to engage with one of the positioning end notches. The first disk is disposed at a side of the second disk and the first disk is located between the supporting bracket and the second disk. The fixing element is disposed at another side of the second disk for mounting the second disk to the supporting bracket and limiting the second disk to move along the rotation axis of the spindle within a preset range. The elastic element is mounted between the fixing element and the second disk for forcing the second disk to lean on the first disk.

According to another embodiment of the present invention, an angle-adjusting assembly adapted to be installed to a projector is provided. The angle-adjusting assembly includes the angle-adjusting mechanism and the supporting bracket. The second disk is disposed at the supporting bracket.

According to another embodiment of the present invention, an angle-adjusting mechanism adapted to be installed between a case and a supporting bracket of a projector is provided. The angle-adjusting mechanism includes a first disk, a second disk, a fixing mandrel and a fixing pin. The first disk has a first center hole and a plurality positioning end notches disposed adjacent to the first center hole. The second disk has a second center hole and at least an elastic portion disposed adjacent to the second center hole, wherein the elastic portion has at least a positioning end bump, the positioning end bump engages with one of the positioning end notches, the first disk is disposed at a side of the second disk and the first disk is located between the supporting bracket and the second disk. The fixing mandrel has a mandrel portion, a head portion and a pin hole. The mandrel portion goes through the first center hole and the second center hole for enabling the second disk to rotate around a rotation axis of the mandrel portion relative to the first disk. The head portion is located at an end of the mandrel portion, an outer diameter of the head portion is greater than the inner diameter of the second center hole, and the pin hole is located at another end of the mandrel portion. The fixing pin passes through the pin hole and together with the head portion to clamp and hold the first disk to force the second disk and the elastic portion to lean on the first disk.

Based on the above description, since an elastic element is used to force one of the positioning end notches to engage with a positioning end bump, therefore, the present invention can facilitate adjusting the angle made by the case and the supporting bracket of a projector that rotate around a rotation axis.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a perspective view of an angle-adjusting mechanism and a supporting bracket according to an embodiment of the present invention.

FIG. 1B is an exploded view of the angle-adjusting mechanism and the supporting bracket in FIG. 1A.

FIG. 1C is another exploded view of the angle-adjusting mechanism and the supporting bracket in FIG. 1A.

FIG. 1D is a front view of the angle-adjusting mechanism and the supporting bracket in FIG. 1A.

FIG. 1E is a sectional view along line A-A of the angle-adjusting mechanism and the supporting bracket in FIG. 1D.

FIG. 2A is a perspective view of an angle-adjusting assembly used in a projector according to an embodiment of the present invention.

FIG. 2B is an exploded view of the angle-adjusting assembly in FIG. 2A used in a projector.

FIGS. 3A-3C are views showing adjustment of angle of a projector by using the angle-adjusting assembly in FIG. 2A.

FIG. 4A is a perspective view of an angle-adjusting mechanism according to another embodiment of the present invention.

FIG. 4B is an exploded view of the angle-adjusting mechanism in FIG. 4A.

FIG. 4C is another exploded view of the angle-adjusting mechanism in FIG. 4A.

FIG. 4D is a front view of the angle-adjusting mechanism in FIG. 4A.

FIG. 4E is a sectional view along line B-B of the angle-adjusting mechanism in FIG. 4A.

FIG. 5A is a perspective view of an angle-adjusting assembly used in a projector according to another embodiment of the present invention.

FIG. 5B is an exploded view of the angle-adjusting assembly and a projector in FIG. 5A.

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

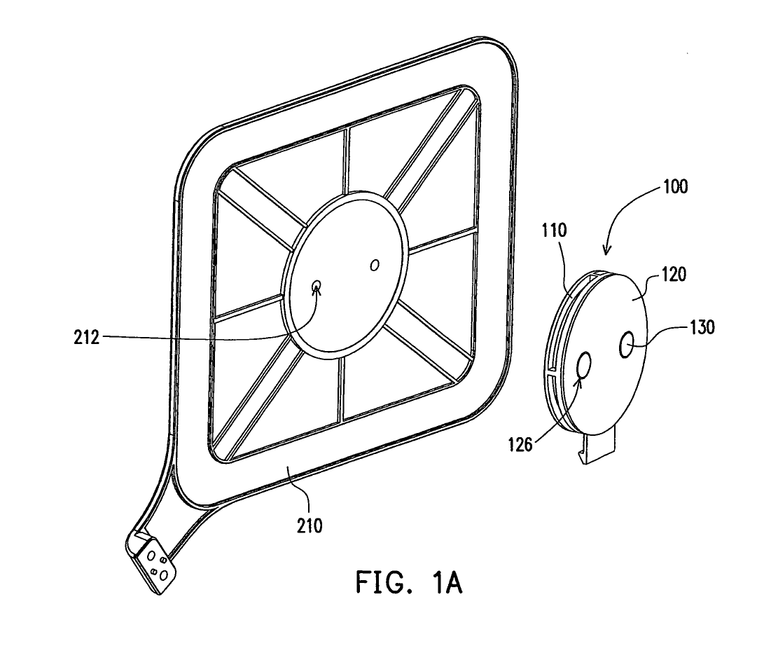

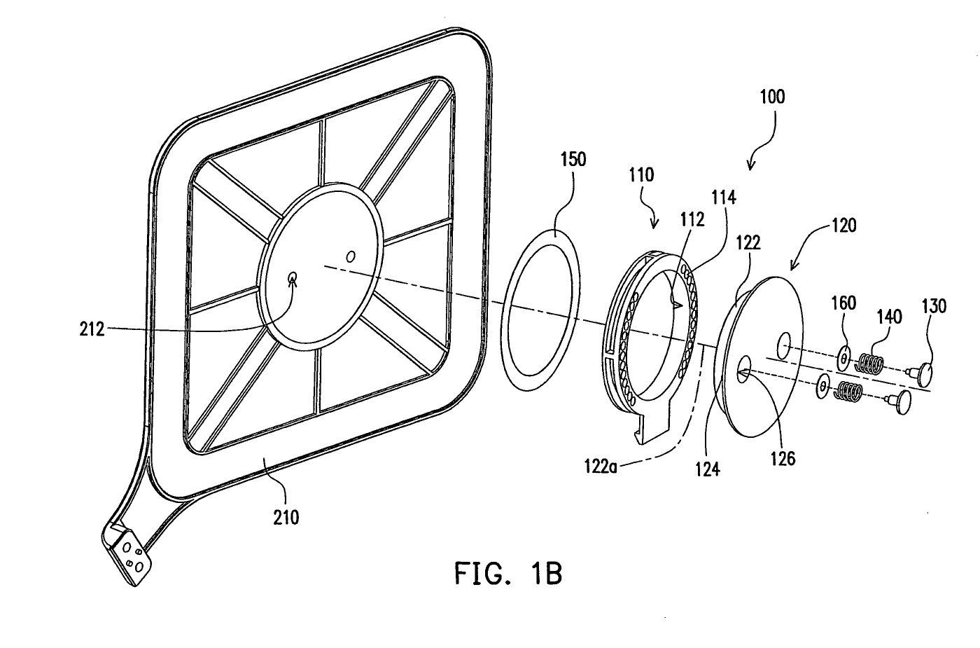

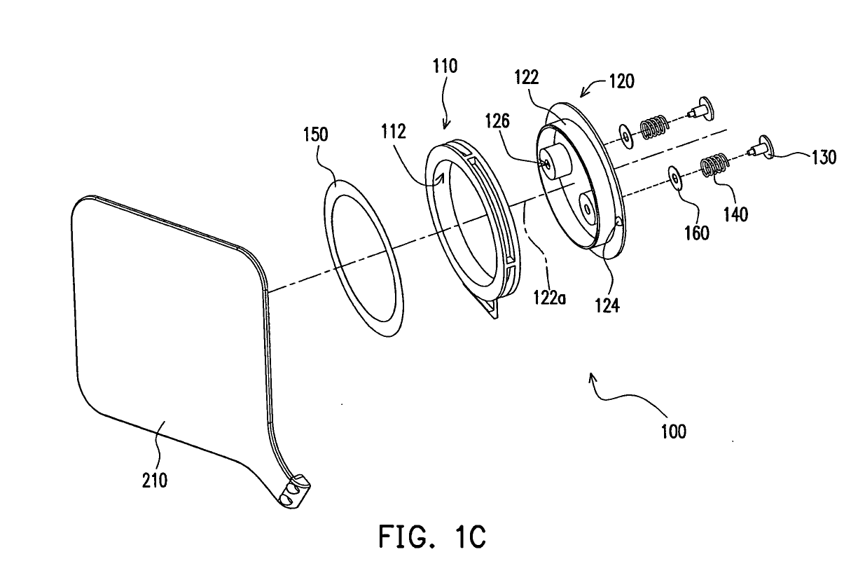

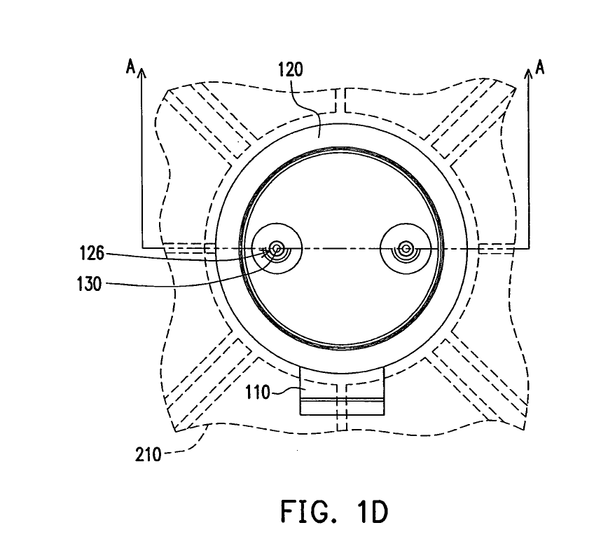

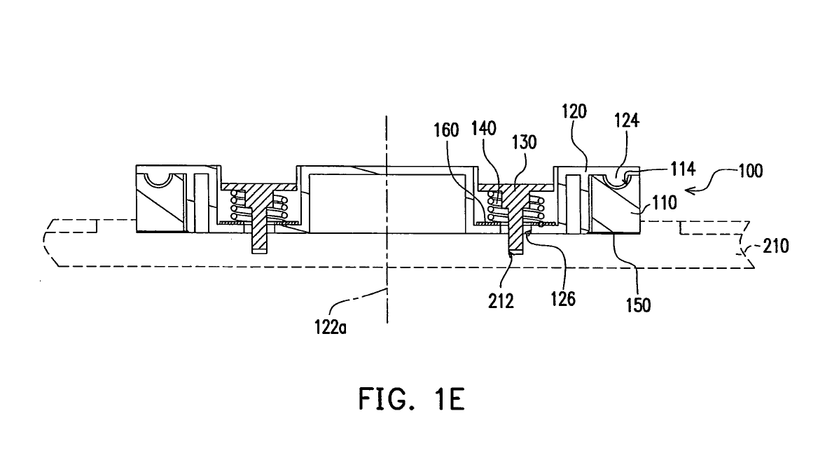

Referring to FIGS. 1A to 1C, an angle-adjusting mechanism 100 according to an embodiment of the present invention is adapted to be installed at a supporting bracket 210. The angle-adjusting mechanism 100 includes a first disk 110, a second disk 120, at least a fixing element 130 and at least an elastic element 140. In the present embodiment, at least one fixing elements 130 and at least one elastic elements 140 are exemplarily depicted.

The first disk 110 comprises a spindle hole 112 and a plurality of positioning end notches 114 disposed adjacent to the spindle hole 112. The second disk 120 comprises a spindle 122 going through the spindle hole 112 and fitting the spindle hole 112 so as to enable the first disk 110 to rotate around a rotation axis 122a of the spindle 122 relative to the second disk 120. The second disk 120 comprises two positioning end bumps 124 (only one of them is shown in FIG. 1C) disposed beside the spindle 122 and each of the positioning end bumps 124 engages with a corresponding positioning end notch in a set of positioning end notches 114 on the first disk 110. The first disk 110 is disposed at a side of the second disk 120 and located between the supporting bracket 210 and the second disk 120.

The fixing elements 130 are disposed at another side of the second disk 120 for mounting the second disk 120 onto the supporting bracket 210 so as to limit the second disk 120 to move along the rotation axis 122a of the spindle 122 within a preset range, and the elastic elements 140 are mounted between the fixing elements 130 and the second disk 120 so as to force the second disk 120 to tightly lean on the first disk 110.

Referring to FIGS. 1D and 1E, in the present embodiment, the fixing elements 130 may comprise bolts, while the elastic elements 140 may comprise helical springs, and a plurality of first fixing holes 126 may be disposed on the second disk 120 and a plurality of second fixing holes 212 corresponding to the first fixing holes 126 may be disposed on the supporting bracket 210. Thus, the fixing elements 130 are able to respectively go through the elastic elements 140 and the first fixing holes 126 of the second fixing holes 212 to be screwed into the second fixing holes 212 so as to tighten the second disk 120 onto the supporting bracket 210 and enable the second disk 120 and the supporting bracket 210 to clamp and hold the first disk 110.

Referring to FIGS. 1B and 1C, in the present embodiment, the positioning end notches 114 may be arranged on the first disk 110 along an arc-shape path and the center of arc of the arc-shape path is located on the rotation axis 122a. Thus, when the first disk 110 rotates relative to the second disk 120 under an external force, the positioning end bumps 124 disengage from one set of the positioning end notches 114 and then engage with the next set of positioning end notches 114. In this way, the positioning end notches 114 associated with the positioning end bumps 124 are able to provide many stepped rotation angles for selection.

In the present embodiment, the angle-adjusting mechanism 100 may further include a plurality of pads 160 disposed between the second disk 120 and the elastic elements 140 so as to prevent the elastic elements 140 from directly rubbing the second disk 120.

It should be noted that the multiple fixing elements 130, a plurality of elastic elements 140 and a plurality of pads 160 are taken as an example, but those skilled in the art may also modify the above embodiment into other configurations. For example, a single fixing element 130 and a single elastic element 140 are applied, and the use of pad 160 between the fixing element 130 and the elastic element 140 may be omitted to practice the present invention.

In the embodiment, the angle-adjusting mechanism 100 may include a washer 150 disposed between the supporting bracket 210 and the first disk 110 so as to prevent the first disk 110 from directly rubbing the supporting bracket 210. The material of the washer 150 may be polytetrafluoroethylene (PTFE).

Since the angle-adjusting mechanism 100 of the present embodiment employs the positioning end notches 114 and the positioning end bumps 124 which are engaged with each other by the elastic action of the elastic elements 140, thus, a user may easily rotate the first disk 110 relative to the second disk 120 around the rotation axis 122a to directly define a relative angle position between the second disk 120 and the first disk 110.

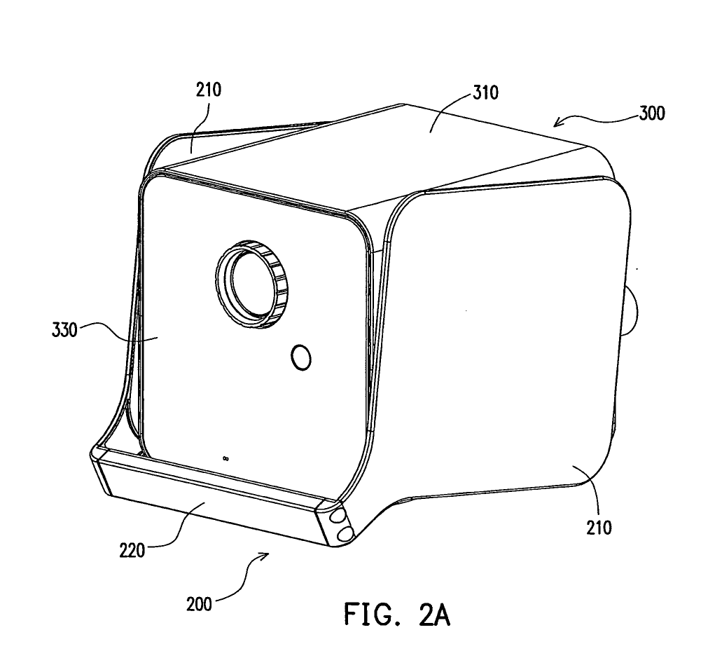

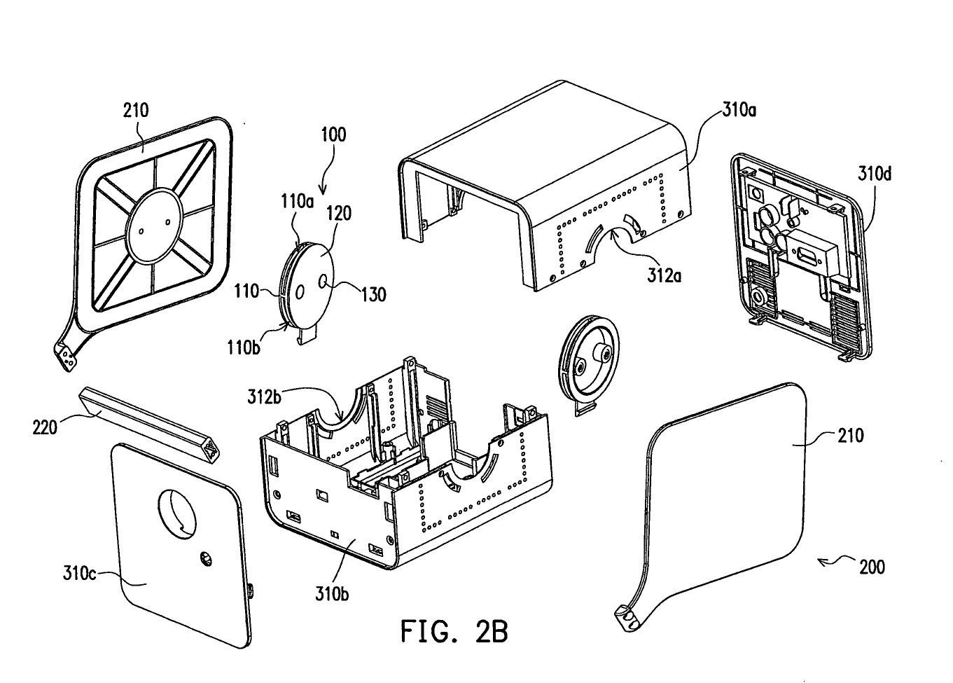

Hereinafter, the angle-adjusting mechanism 100 used to adjust angle in a projector may be exemplarily explained. Referring to FIGS. 2A and 2B, an angle-adjusting assembly 200 suitable for a projector 300 having a case 310 is shown. The angle-adjusting assembly 200 includes two angle-adjusting mechanisms 100, two supporting brackets 210 and a front rail 220 connected to the supporting brackets 210. The angle-adjusting mechanisms 100 are disposed between the supporting brackets 210 and the case 310. The method of disposing the angle-adjusting mechanism 100 on the supporting bracket 210 has been disclosed in detail hereinbefore, and therefore the description is omitted.

The case 310 includes an upper case 310a, a lower case 310b, a front cover 310c and a rear cover 310d. The upper case 310a has two upper insertion flanges 312a and the lower case 310b has two lower insertion flanges 312b. The first disk 110 of each angle-adjusting mechanism 100 comprises an upper insertion slot 110a and a lower insertion slot 110b, and the upper insertion flanges 312a are respectively inserted into the upper insertion slots 110a, while the lower insertion flanges 312b are respectively inserted into the lower insertion slots 110b so as to fix the first disks 110 onto the case 310.

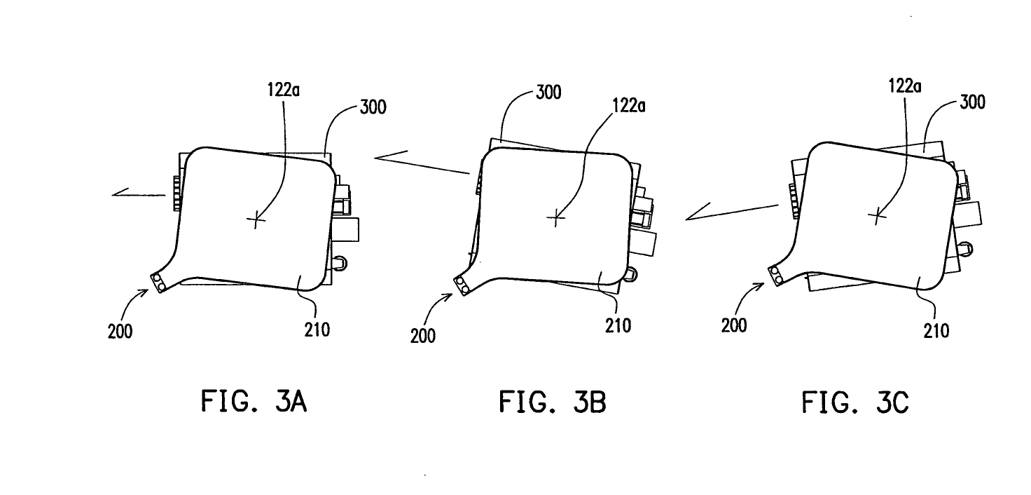

Since the first disks 110 are fixed on the case 310 and the second disks 120 are fixed on the supporting brackets 210, therefore, a user may vertically adjust the projection angles of the projector 300 by rotating the case 310 of the projector 300 relative to the supporting brackets 210 around the rotation axis 122a, as shown in FIGS. 3A to 3C.

In the present embodiment, since two supporting brackets 210 are disposed at both sides of the projector 300, and therefore the projector 300 is firmly supported and is not easily swayed.

It should be noted that although the two angle-adjusting mechanisms 100 are taken as an example, but the present invention does not limit thereto. Those skilled in the art may also dispose a single angle-adjusting mechanisms 100 between the case 310 of the projector 300 and a base (not shown) being in contact with a table to horizontally adjust the projection angles of a projector by rotating the case 310 of the projector 300 relative to the above-mentioned base around the rotation axis 122a.

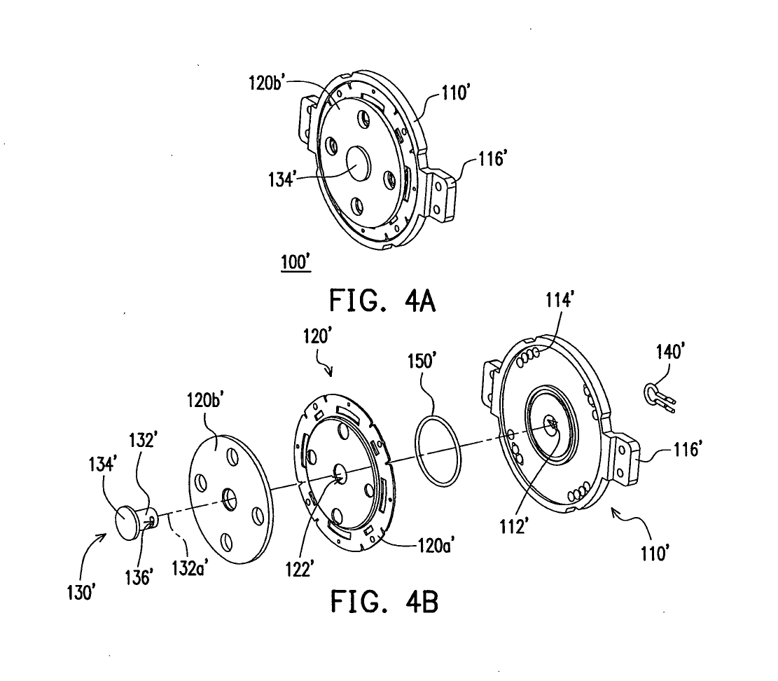

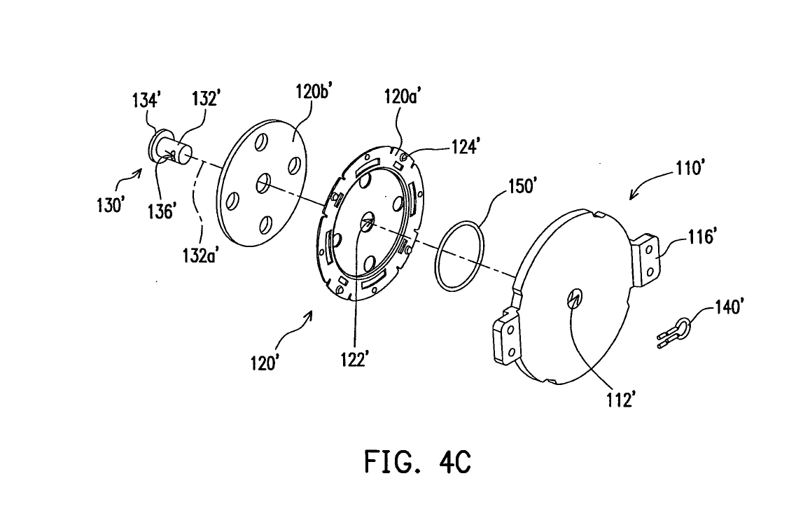

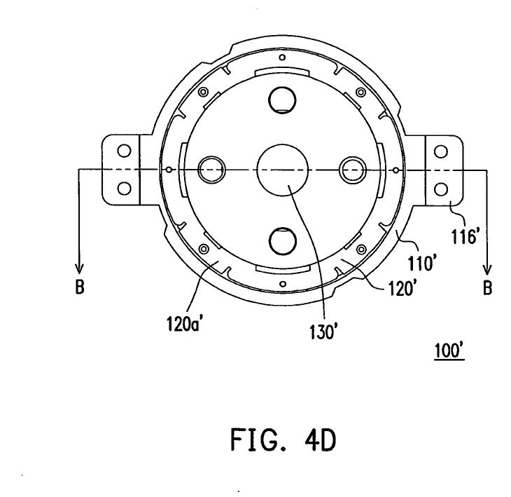

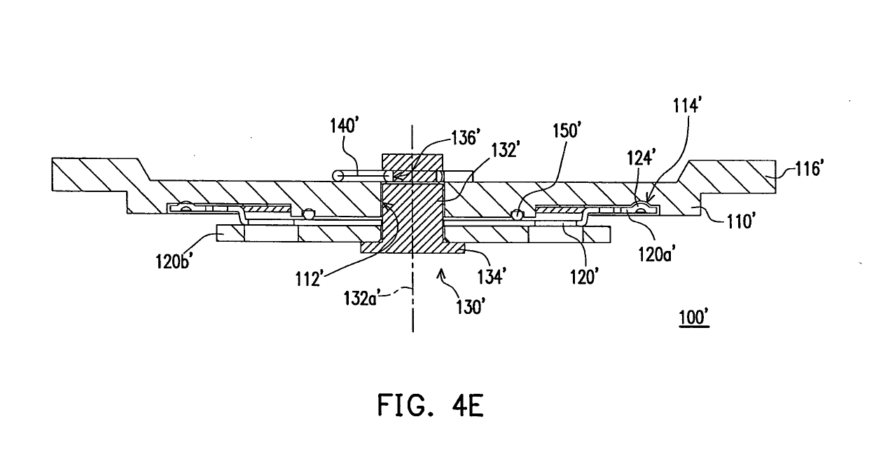

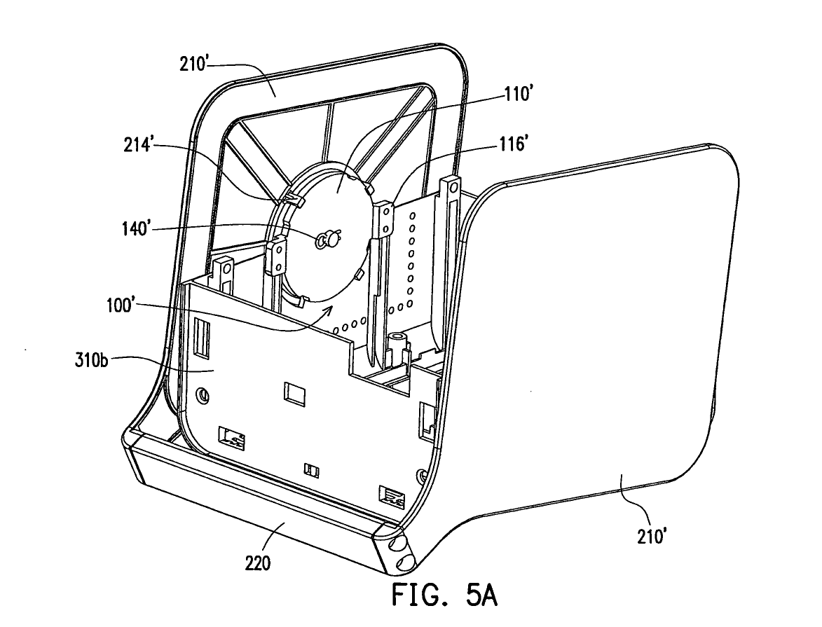

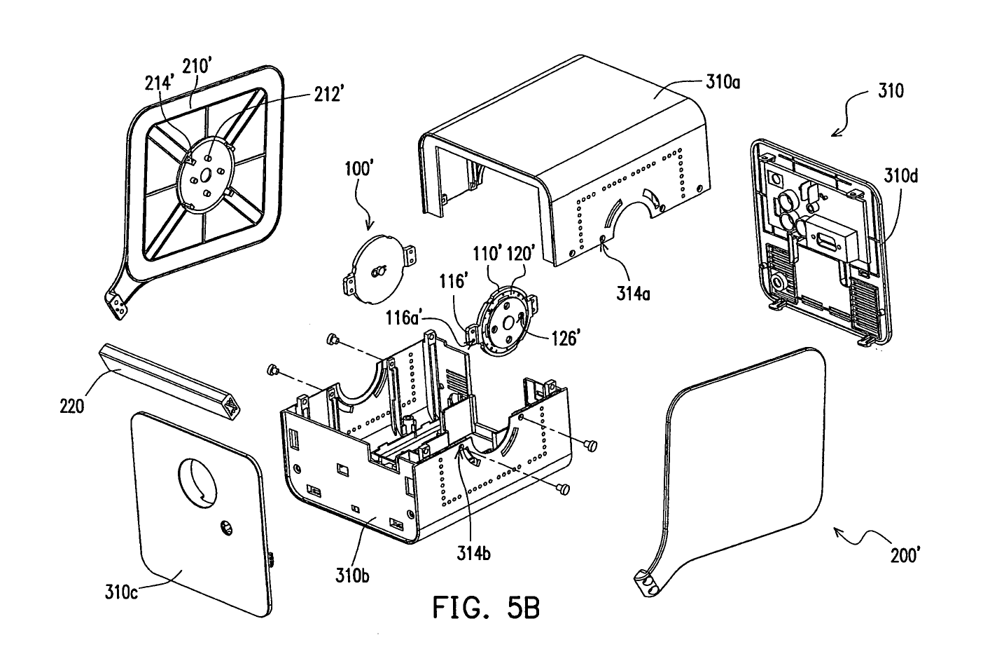

Referring to FIGS. 4A to 4C, an angle-adjusting mechanism 100′ provided by another embodiment of the present invention is adapted to a supporting bracket 210′ (shown by FIGS. 5A and 5B). The angle-adjusting mechanism 100′ includes a first disk 110′, a second disk 120′, a fixing mandrel 130′ and a fixing pin 140′.

The first disk 110′ comprises a first center hole 112′ and a plurality of positioning end notches 114′ disposed adjacent to the first center hole 112′. The second disk 120′ has a second center hole 122′ and a plurality of elastic portions 120a′ disposed adjacent to the second center hole 122′. Each the elastic portion 120a′ has a positioning end bump 124′ and the positioning end bumps 124′ respectively engage with one set of the positioning end notches 114′. The first disk 110′ herein is disposed at a side of the second disk 120′ and located between the supporting bracket 210′ and the second disk 120′.

The fixing mandrel 130′ has a mandrel portion 132′, a head portion 134′ and a pin hole 136′, and the mandrel portion 132′ passes through the first center hole 112′ and the second center hole 122′ so as to enable the second disk 120′ to rotate around a rotation axis of the mandrel portion 132′ relative to the first disk 110. The head portion 134′ is located at an end of the mandrel portion 132′ and an outer diameter of the head portion 134′ is greater than an inner diameter of the second center hole 122′, while the pin hole 136′ is located at another end of the mandrel portion 132′.

Referring to FIGS. 4D and 4E, the fixing pin 140′ passes through the pin hole 136′ and together with the head portion 134′ clamp and hold the first disk 110′ and the second disk 120′ so as to force the second disk 120′ and the elastic portions 120a′ to tightly lean on the first disk 110′.

Referring to FIGS. 4B and 4C, in the present embodiment, the positioning end notches 114′ may be arranged on the first disk 110′ along an arc-shape path and the center of arc of the arc-shape path is located on the rotation axis 132a′ so as to enable the positioning end bumps 124′ to respectively engage with one set of the positioning end notches 114′. The elastic portions 120a′ may be arranged along an edge of the second disk 120′ to make the positioning end bumps 124′ respectively engage with one set of the positioning end notches 114′. Thus, when the first disk 110′ rotates relative to the second disk 120′ under an external force, the positioning end bumps 124′ would disengage from one set of the positioning end notches 114′ and then engage with the next set of positioning end notches 114′. In this way, the positioning end notches 114′ associated with the positioning end bumps 124′ are able to provide many stepped rotation angles for selection.

In addition, the angle-adjusting mechanism 100′ may further include a washer 150′ disposed between the first disk 110′ and the second disk 120′, and the washer 150′ is, for example, a rubber ring. Besides, the second disk 120′ may have a strengthening element 120b′ located between the head portion 134′ and the second disk 120′ and corresponding to the position of the second center hole 122′ to enhance the rigidness of the second disk 120′.

In the following, an application example for adjusting the angle of a projector by using an angle-adjusting mechanism 100′ is described. Referring to FIGS. 5A and 5B, an angle-adjusting assembly 200′ is adapted to a projector 300 having a case 310. The angle-adjusting assembly 200′ includes two angle-adjusting mechanisms 100′, two supporting brackets 210′ and a front rail 220 connecting the supporting brackets 210′. The first disks 110′ are fixed on the case 310 and the second disks 120′ are respectively fixed on the supporting brackets 210′.

The angle-adjusting assembly 200′ is similar to the angle-adjusting assembly 200 (as shown by FIG. 2B), except for the following differences. In the present embodiment, the first disk 110′ comprises two lobes 116′ and each lobe 116′ comprises a plurality of first thread holes 116a′. The upper case 310a comprises a plurality of second thread holes 314a respectively corresponding to the first thread holes 116a′, while the lower case 310b comprises a plurality of third thread holes 314b respectively corresponding to the first thread holes 116a′. Thus, the angle-adjusting mechanisms 100′ may be fixed onto the case 310 by respectively tightening a plurality of screws into the first thread holes 116a′ and the second thread holes 314a or by respectively tightening a plurality of screws into the first thread holes 116a′ and the third thread holes 314b.

The second disk 120′ may have a plurality of fixing holes 126′ and the supporting brackets 210′ may have plurality of fixing end bumps 212′, and the fixing end bumps 212′ respectively pass through the fixing holes 126′ to prevent the second disk 120′ from rotating around the rotation axis 132a′ relative to the supporting brackets 210′. In addition, each of the supporting brackets 210′ may comprise a plurality of hooks 214′ which defines the position of the first disk 110′ relative to the supporting brackets 210′, so that the first disk 110′ is unable to move relative to the supporting brackets 210′ along the rotation axis 132a′.

In summary, the projector according an embodiment of the present invention allows a user to vertically or horizontally adjust the projection angles of the projector by rotating the case and the supporting bracket of a projector around a rotation axis. In addition, two supporting brackets are disposed at both sides of a projector so as to more firmly place the projector on a table without sway.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An angle-adjusting mechanism, adapted to be installed between a case and a supporting bracket of a projector, the mechanism comprising:
a first disk, having a spindle hole and a plurality of positioning end notches disposed adjacent to the spindle hole;
a second disk, having a spindle fitting the spindle hole for enabling the first disk to rotate around a rotation axis of the spindle relative to the second disk, and having at least a positioning end bump disposed adjacent to the spindle to engage with one of the positioning end notches, wherein the first disk is disposed at a side of the second disk and located between the supporting bracket and the second disk;
at least a fixing element, disposed at another side of the second disk for mounting the second disk to the supporting bracket and limiting the second disk to move along the rotation axis of the spindle within a preset range; and
at least an elastic element, mounted between the fixing element and the second disk to force the second disk to lean on the first disk.

2. The angle-adjusting mechanism according to claim 1, wherein the positioning end notches are arranged on the first disk along an arc-shape path and a center of arc of the arc-shape path is located on the rotation axis.

3. The angle-adjusting mechanism according to claim 1, wherein the fixing element comprises a bolt, the elastic element comprises a helical spring, and the fixing element is capable of passing through the elastic element and the second disk to be screwed into the supporting bracket.

4. The angle-adjusting mechanism according to claim 1, further comprising a washer, disposed between the first disk and the supporting bracket.

5. The angle-adjusting mechanism according to claim 4, wherein a material of the washer is polytetrafluoroethylene (PTFE).

6. An angle-adjusting assembly, adapted to be installed into a projector, the assembly comprising:
a supporting bracket;
an angle-adjusting mechanism, comprising:
a first disk, having a spindle hole and a plurality of positioning end notches disposed adjacent to the spindle hole;
a second disk, having a spindle fitting the spindle hole for enabling the first disk to rotate around a rotation axis of the spindle relative to the second disk, and having at least a positioning end bump disposed adjacent to the spindle to engage with one of the positioning end notches, wherein the first disk is disposed at a side of the second disk and located between the supporting bracket and the second disk;
at least a fixing element, disposed at another side of the second disk for mounting the second disk to the supporting bracket and limiting the second disk to move along the rotation axis of the spindle within a preset range; and
at least an elastic element, mounted between the fixing element and the second disk to force the second disk to lean on the first disk.

7. The angle-adjusting assembly according to claim 6, wherein the positioning end notches are arranged on the first disk along an arc-shape path and a center of arc of the arc-shape path is located on the rotation axis.

8. The angle-adjusting assembly according to claim 6, wherein the fixing element comprises a bolt, the elastic element comprises a helical spring, and the fixing element is capable of passing through the elastic element and the second disk to be screwed into the supporting bracket.

9. The angle-adjusting assembly according to claim 6, further comprising a washer disposed between the first disk and the supporting bracket.

10. The angle-adjusting assembly according to claim 9, wherein a material of the washer is polytetrafluoroethylene (PTFE).

11. An angle-adjusting mechanism, adapted to be installed between a case and a supporting bracket of a projector, the mechanism comprising:
a first disk, having a first center hole and a plurality of positioning end notches disposed adjacent to the first center hole;
a second disk, having a second center hole and at least an elastic portion disposed adjacent to the second center hole, wherein the elastic portion comprises at least a positioning end bump, the positioning end bump engages with one of the positioning end notches, and the first disk is disposed at a side of the second disk and located between the supporting bracket and the second disk;
a fixing mandrel having a mandrel portion, a head portion and a pin hole, wherein the mandrel portion passes through the first center hole and the second center hole for enabling the second disk to rotate around a rotation axis of the mandrel portion relative to the first disk, the head portion is located at an end of the mandrel portion, an outer diameter of the mandrel portion is greater than an inner diameter of the second center hole, and the pin hole is located at another end of the mandrel portion; and
a fixing pin passing through the pin hole together with the head portion clamping the first disk to force the second disk and the elastic portion to lean on the first disk.

12. The angle-adjusting mechanism according to claim 11, wherein the positioning end notches are arranged on the first disk along an arc-shape path and a center of arc of the arc-shape path is located on the rotation axis.

13. The angle-adjusting mechanism according to claim 11, wherein the elastic portions are arranged along an edge of the second disk.

14. The angle-adjusting mechanism according to claim 11, further comprising a washer, disposed between the first disk and the second disk.

15. The angle-adjusting mechanism according to claim 11, wherein the second disk further comprises a strengthening component located between the head portion and the second disk, and corresponding to a position of a second center hole.
